(19) United States
(12) Patent Application Publication
(10) Pub. No.: US 2002/0106621 A1
(43) Pub. Date: Aug. 8, 2002

(54) Vocal training and companionship apparatus

(75) Inventor: Glenn R. Godley, Cleveland, OH (US)

Correspondence Address: LAW OFFICES OF JOHN D. GUGLIOTTA, PE, ESQ., 202 DELAWARE BUILDING, 137 SOUTH MAIN STREET, AKRON, OH, 44308, US

(73) Assignee: OurPet's Company

(21) Appl. No.: 09/778,543

(22) Filed: Feb. 7, 2001

(51) Int. Cl. G09B 5/04

(52) U.S. Cl. 434/319

(57) ABSTRACT

The present invention relates to an apparatus for teaching a subject, such as an animal or child, how to vocally emulate desired sounds. Specifically, the present invention plays back a desired prerecorded sound when a sensor detects the presence of the subject. Furthermore, the present invention may provide a recording function, which allows the subject's trainer or parent to record a sound, that he or she wishes the subject to learn. This predetermined sound is then stored by the device and is played back allowing the subject to hear the sound when the sensing device detects the subject's presence. Because the subject's movement dictates the sound playback, the subject's learning of how to emulate the desired sound is facilitated. Additionally, the sound playback also provides comfort and companionship to the subject, thereby enhancing its quality of life.

### TECHNICAL FIELD

The present invention relates generally to an apparatus for teaching subjects such as animals and children to vocally emulate prerecorded sounds. Additionally, this invention provides an animal or child subject with companionship and mental stimulation. Specifically, the present invention involves the use of a sensing device to determine the presence of a subject. When the sensor determines that the subject is near the sensor, the system initiates playback of a prerecorded sound. This provides the subject with the opportunity to hear the message multiple times, thereby facilitating the subject's ability to repeat (i.e. learn) or respond to the prerecorded message.

### BACKGROUND OF THE INVENTION

Teaching a subject such as a bird to vocally emulate a predetermined sound such as a phrase generally takes a large amount of time and effort on behalf of the bird's owner. The owner must continuously repeat the desired phrase over the course of a period of time in order for the bird to be trained to say the desired phrase or sound. During the period it takes to train the bird, the bird's trainer/owner has expended time that he or she could have dedicated to other activities. Furthermore, once the bird is trained, its trainer/owner must reinforce the learned phrase so that the bird does not forget the phrase over time. If the owner does not consistently train or reinforce the bird's memory, it is likely that the bird will not achieve the goal of maintaining the acquired skill of being able to say the desired phrase.

Additionally, many birds lack the mental stimulation and companionship provided by the presence of the bird's owner and by other birds. Bird owners that have busy schedules may purchase bird toys to provide the bird with mental stimulation. However, these toys are often consumable, needing regular replacement.

Therefore, in light of the foregoing deficiencies in the prior art, the applicant's invention is herein presented.

### SUMMARY OF THE INVENTION

It is an object of the present invention to facilitate the training of a subject, such as a child or animal, to vocally emulate desired sounds and to provide the subject with mental stimulation and companionship. One preferred embodiment of the present invention is comprised of a playback system, sensor, and housing. The playback system, allows a predetermined message to be played back so that either a human or animal can hear the message. Thus, a selector switch would be utilized, thereby allowing one to select one of the stored, pre-recorded sounds, such as a song, whistle, or any other audible sound to be played back. To further enhance the system, a recording system may be incorporated into the design of the present invention. The trainer or parent would then record their own customized message that could be comprised of any audible sound. Other embodiments of the present invention include the use of a playback system and recording system that is responsive to high frequency sounds that are inaudible to humans but are capable of being recognized by animals. As the subject interacts with the present invention, a sensor notifies the system of the bird's presence and initiates playback of the prerecorded phrase or message. This sensor may be initiated based on movement, light, heat (thermal), sound, or the like. By initiating playback based on the presence of the animal or child, the trainer/parent does not have to be present for the subject to learn to vocally emulate the desired sound. Because the movement or presence of the subject initiates the replay of the phrase, the subject's learning of the phrase or sound is accelerated and then reinforced by continuing use of the device. This ensures that the subject's memory of how to vocally repeat the learned sound does not degrade with the passage of time. The playback and sensing systems are housed in a housing for protection from dust and dirt.

Specifically, when the present invention is used for training a bird, additional items such as a bird perch, reflecting mirror and a trough for bird food/water may be added to create an incentive for the bird to interact with the present invention but are not necessary. Furthermore, other types of incentives could be used such as a picture of another bird or animal, or any other type of visual stimulus.

Another aspect of the present invention is its ability to provide a sense of comfort and mental stimulation for a subject when its trainer or parent is not able to interact with the subject. The predetermined message may be comprised of a comforting statement such as the voice of the bird's owner, or any comforting phrase or sound. Additionally, the sound of the trainer or parent's voice provides mental stimulation for the subject, thereby increasing the quality of life for the animal or child.

### SUMMARY OF THE DRAWINGS

FIG. 1 is a perspective view of the training device 10 with the perch assembly 18 attached.

FIG. 2 is an elevational view of the training device 10 without the perch assembly 18 attached.

FIG. 3 is a top plan view of perch assembly 18.

FIG. 4 is a back elevational view of the training device 10, which illustrates the user controls and mounting system of the present invention.

FIG. 5 is an elevational view of the training device's mounting plate 34.

FIG. 6 is an elevational view of the training mirror 10 when used with subjects such as animals or humans in general.

FIG. 7 is a left side view of the training mirror 10.

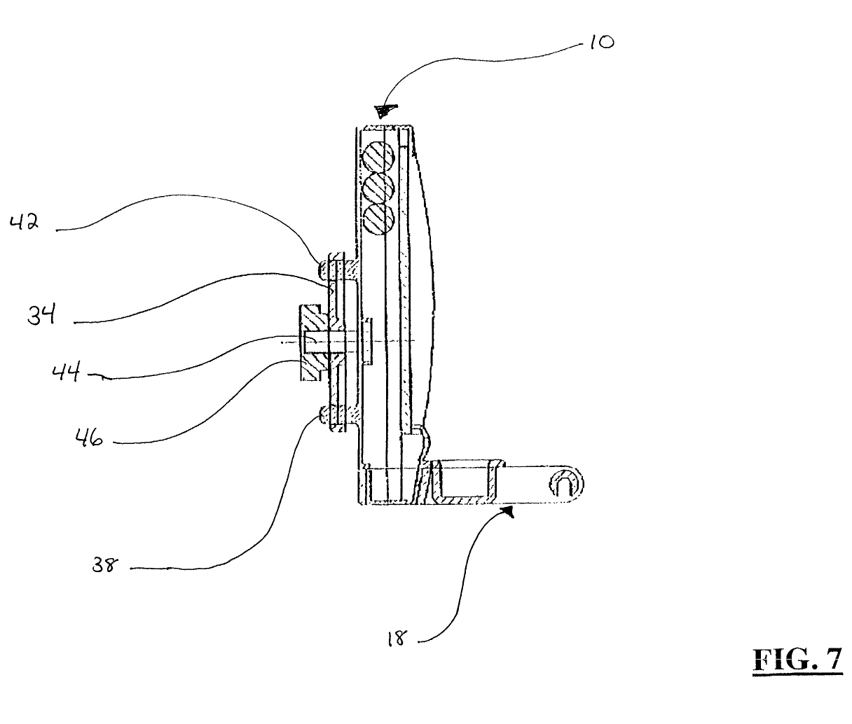

### DETAILED DESCRIPTION OF THE PREFERRED EMBODIMENTS

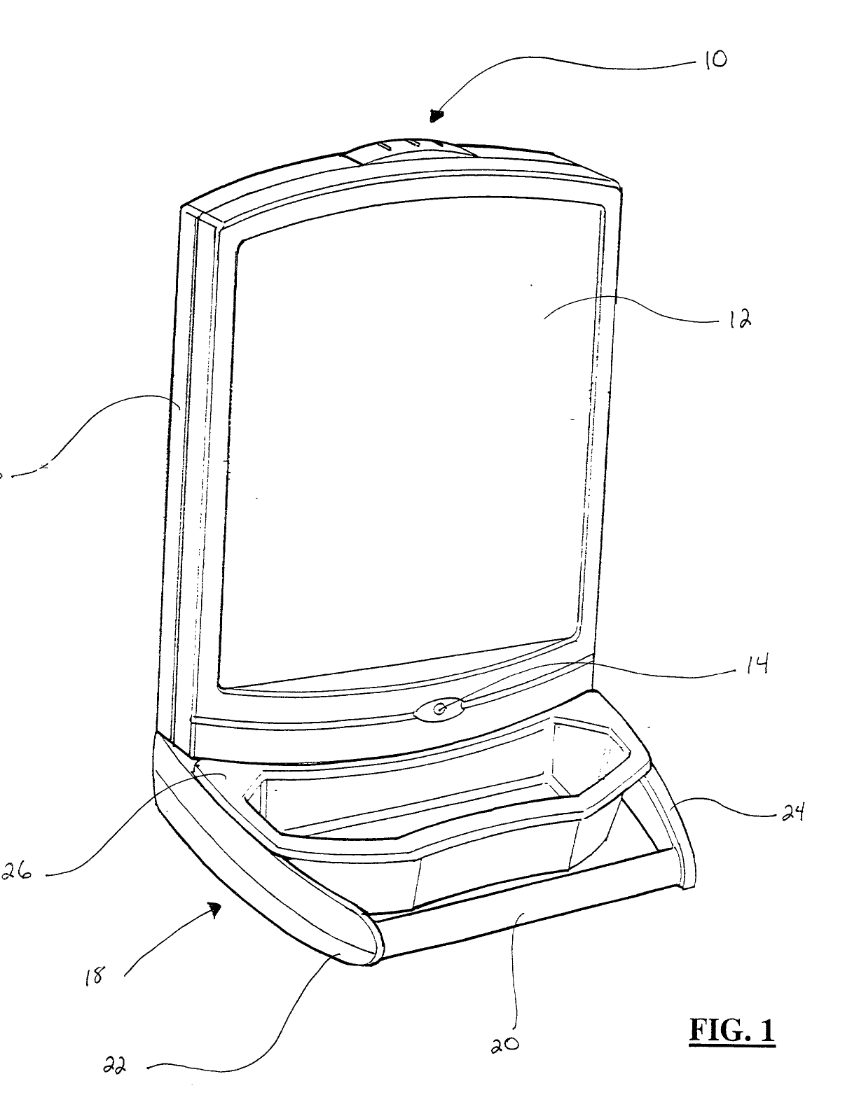

A preferred recordable training device 10 for use with a bird is described in FIG. 1. The training device 10 includes a reflecting mirror 12, allowing the bird to view its own reflection, thereby providing the bird with a sense of companionship. However, pictures such as those of another bird, or other stimulation device could be used in lieu of the mirror 12. Sensor 14 detects the presence of the bird and initiates the playback of a prerecorded voice or sound message recorded by the bird's owner or trainer.

One preferred sensor 14 is a motion sensor, whereby the movement of the bird will initiate the playback of the prerecorded message. Further embodiments are contemplated for the sensor 14, such as a light sensor, which is activated when light is cut off from the sensor as a result of the bird's proximity to the training device 10. A heat sensor may also be used whereby the heat of the bird's body activates the sensor 14 and initiates the playback of the prerecorded message. A laser and laser-sensing device could also be utilized, whereby the bird's presence near the training device 10 would block the laser beam, thereby initiating the playback of the prerecorded message. The mirror 12 and sensor 14 are encased in a polypropylene frame 16, however materials such as plastic or metal may be used.

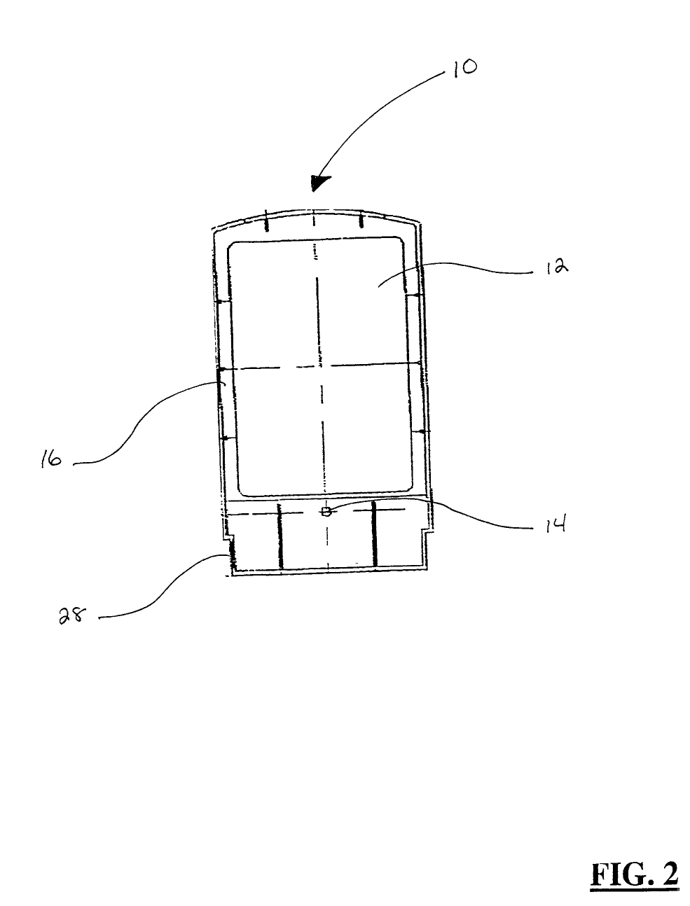

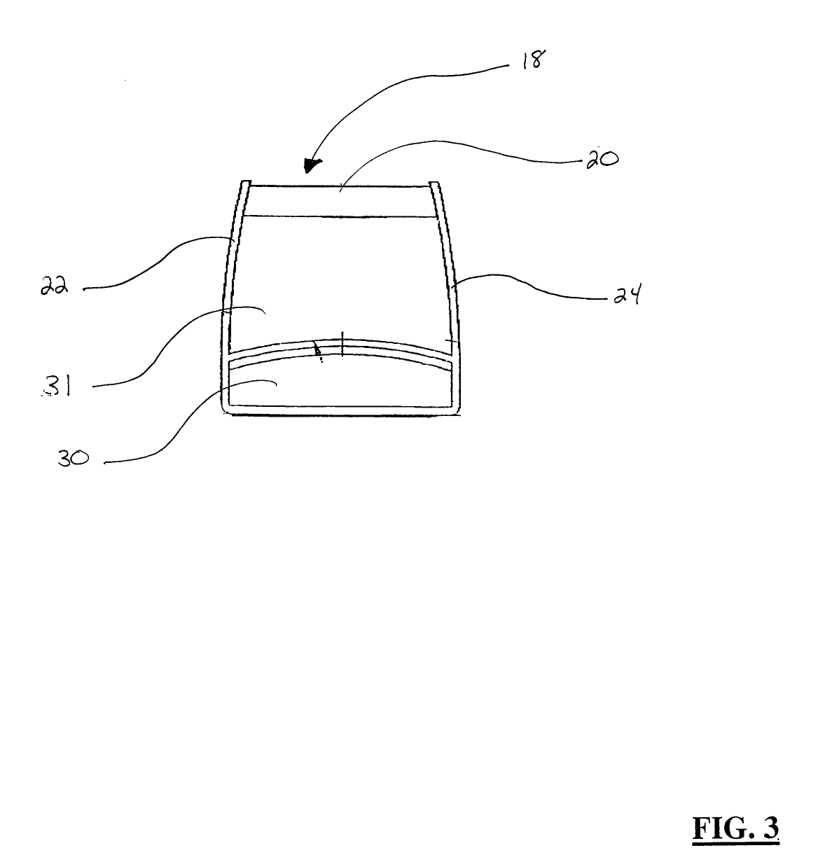

Perch assembly 18 contains right 24 and left 22 members, which support the bird's perch The opening 30 of perch assembly 18, as shown in FIG. 3 allows the perch assembly 18 to connect the base 28 of training device 10 as shown in FIG. 2, by a snap fit, screws, press fit, or any other suitable means known by one with ordinary skill in the art. However, this perch assembly 18 may be integrated into the design of the housing 16 without being a separate piece. By connecting the perch assembly 18 to the base 28 of the training device 10, a fully integrated bird perch is created. The perch 20 allows the bird to be in close proximity with the training device 10 and sensor 14. Because the bird is in close proximity to the sensor 14 accurate playback is initiated only by the bird's movement not by collateral external activity. In addition, the present invention has the option of not using the perch assembly 18 in conjunction with base 28 of the training device 10. Furthermore, the present invention 10 may include a seed or water trough 26 that can be inserted into the void (open space) 31 created by the perch assembly 18, as shown in FIG. 3.

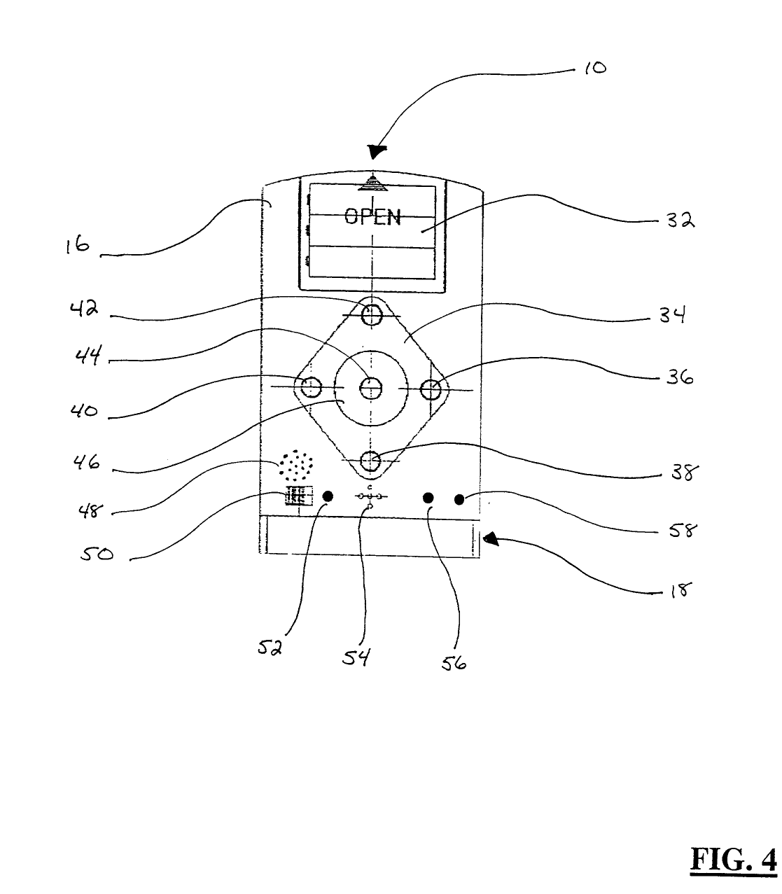

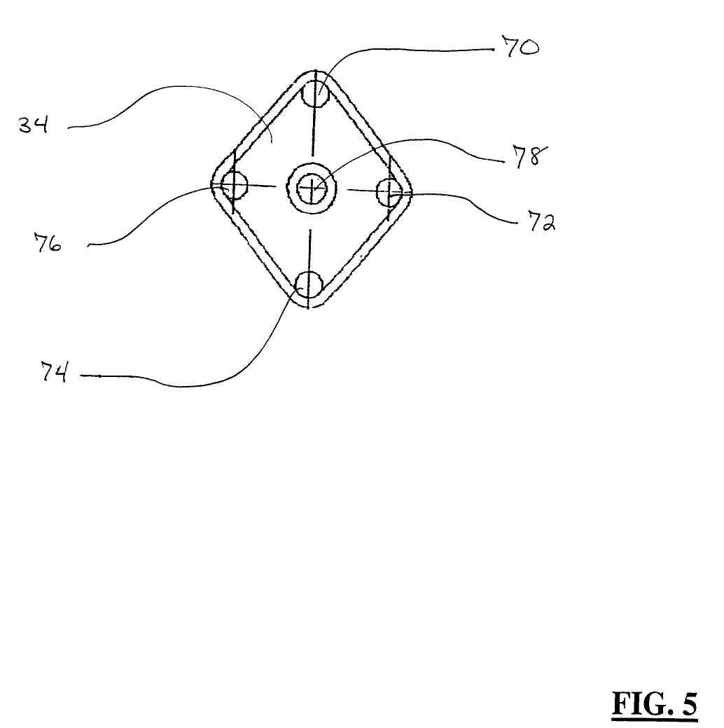

FIG. 4 illustrates the reverse side of the training device 10. The present invention 10 includes a battery cover 32, which is slideably removed for gaining access to a battery compartment. To position or mount the training device 10, the device may be oriented so that it simply sits on a floor or table, or other surface. Furthermore, the training device can be affixed in a desired position using a common means of attachment such as abracket, adhesives, loop and hook, or any other suitable means known by one of ordinary skill in the art. In this embodiment, the training device 10, mounting pins 36, 38, 40, 42 and threaded pin 44 of the training mirror 10 are positioned through the bars of the bird's cage. A mounting plate 34 as shown in FIG. 5 is arranged so that the mounting plate holes 70, 72, 74, 76, and 78 allow the mounting pins 36, 38, 40, 42, and threaded pin 44 of training device 10 to pass through. To secure the training mirror 10, a thumb wheel 46 is threaded onto threaded pin 44. By tightening the thumb wheel 46, a compressive force is created by the mounting plate 34 and the training device 10 against the birdcage, thereby holding the training device 10 in the desired position.

To prepare the present invention 10 for use, the on/off switch 50 is put into the “ON” position. By putting the on/off switch 50 into the “ON” position, the present invention 10 is both ready to record and ready to detect the presence of the bird. Next, to record a message, the record button 58 is depressed, which illuminates an LED light 52 indicating that the training device 10 is ready to record a message. While continuing to depress the record button 58, the user records the desired sound that he or she wishes the bird to learn while speaking into the microphone 54. This phrase or message may be comprised of a song, whistles, the trainer's own voice, or any other audible sound that the trainer desires the bird to emulate. However, the training device 10 could be designed to record and playback sounds that are not audible to humans but are recognizable by animals such as birds. The user is given a predetermined amount of time in which a message can be recorded. If the user attempts to record a message that is longer than the specified limit, the LED indicator 52 will stop illuminating and the recording function will stop. In the event that the user elects to record a phrase that is shorter than the device's maximum time limit, the user, may release the record button 58 to stop the recording process at the desired point.

Once the recording process is completed the message is stored by the invention's memory, and the user may replay it by depressing the play button 56. Once the play button 56 is depressed, the playback speaker 48 transmits the playback. By playing back the recorded message, the user can test the clarity and volume of the recorded sound. After the message is recorded, the training device 10 is ready for use, and playback of the prerecorded message will be initiated when the sensor 14 detects the presence of the bird near the training mirror 10. By putting the on/off switch 50 into the “OFF” position, the recording and playback feature of the training device 10 is made inoperable. To erase a previous recorded message, the owner simply re-records a new message by depressing and holding the record button 58, which initiates the aforementioned recording sequence. A preferred embodiment which does not include the perch assembly 18 and trough 26 is suitable for applications for training subjects such as animals and children.

Further embodiments of the present invention 10 may be comprised of a playback system without a recording feature. The playback system would contain prerecorded phrases, whistles, or any other sound that is audible to an animal or human. A selector switch may then be used to choose the desired message to be played. Also, a volume control feature is contemplated wherein the sound output level of the training device 10 may be reduced or increased via a volume control. Additionally, a system that would increase or decrease the frequency in which the recorded sound is played back independently of the detection by the sensor 14 is also contemplated.

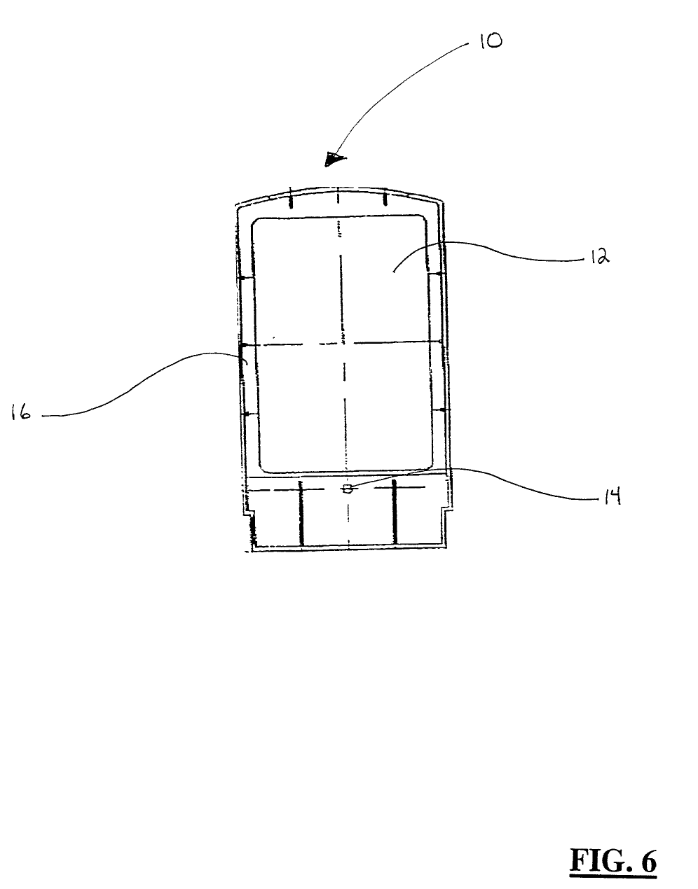

The preferred embodiment illustrated in FIG. 6 describes a training device 10 that can be used for subjects such as animals or children in general. This preferred embodiment of the present invention 10 is identical to the aforementioned preferred embodiment, which is used for a bird, with the exception of the bird perch assembly 18, which is unnecessary. Specifically, training device 10 contains a mirror 12 that provides an incentive for the subject to engage in interacting with the training device 10. However, a picture of the child's mother or father, picture of another animal, or other type of comforting image may be substituted in place of the training device's mirror 10. A sensing device 14 is used to detect the presence or absence of the subject and to initiate the playback of the recorded sound. To mount the training device 10, any typical means of attachment such as adhesives, hook and loop, or any other type of attachment means known by one skilled in the art may be used. Furthermore, the training device 10 is capable of freely standing alone in a desired position without the need of any attachment or mounting means.

The foregoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

1. An apparatus to teach a subject to vocally emulate sounds comprising:
a sensor for detecting the presence of a subject;
a system for playing back a predetermined message, where the system initiates playback of said predetermined message upon the detection of the presence of the person or animal by the sensor; and
a housing which contains the sensor and the playback initiation system.

2. An apparatus as recited in claim 1 further comprising a system for selecting a prerecorded sound to be played.

3. An apparatus as recited in claim 1 further comprising a system for recording sounds that are audible to human beings.

4. An apparatus as recited in claim 1 further comprising a system for recording sounds that are audible to animals.

5. An apparatus as recited in claim 1 wherein, the sensor comprises:
a movement sensing device.

6. An apparatus as recited in claim 1 wherein, the sensor comprises:
a light sensing device for detecting the absence of light due to the presence of the bird.

7. An apparatus as recited in claim 1 wherein, the sensor comprises:
a laser and a laser detection sensor.

8. An apparatus as recited in claim 1 wherein, the sensor for detecting the presence of a bird comprises:
a heat sensing device.

9. An apparatus as recited in claim 1 further comprising a bird perch.

10. An apparatus as recited in claim 9, wherein the bird perch is detachable.

11. An apparatus as recited in claim 1 further comprising a mirror.

12. An apparatus as recited in claim 11, wherein the mirror is contained within the housing.

13. An apparatus as recited in claim 1 further comprising a means for attaching the apparatus to a birdcage.

14. An apparatus as recited in claim 13 wherein, the means for attaching the apparatus to a birdcage comprises a bracket.

15. An apparatus as recited in claim 1 wherein, the apparatus is capable of freely standing.

16. An apparatus as recited in claim 9 further comprising a trough.

17. An apparatus as recited in claim 16 wherein the trough is inserted within the space created by the bird perch.

18. A method of teaching a subject to vocalize sounds comprising:
selecting a prerecorded sound to be played back by a playback system;
detecting the subject's presence by a sensor; and
upon the sensor's detection of the subject, the prerecorded sound is played back for the
subject to hear, whereby the subject learns to vocally emulate the desired sound.
